(19) United States
(12) Patent Application Publication
(10) Pub. No.: US 2006/0120593 A1
(43) Pub. Date: Jun. 8, 2006

(54) 3D image generation program, 3D image generation system, and 3D image generation apparatus

(76) Inventor: Takahiro Oshino, Utsunomiya-shi (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/293,524

(22) Filed: Dec. 2, 2005

(30) Foreign Application Priority Data
Dec. 3, 2004 (JP) 2004-350577 (PAT.

(51) Int. Cl. G06K 9/00

(52) U.S. Cl. 382/154

(57) ABSTRACT

A 3D image generation program for generating a 3D image capable of producing stereopsis for a plurality of observation positions includes a first step of inputting a 3D scene, and a second step of generating information of a pixel of the 3D image on the basis of the 3D scene, wherein in the second step, the information of the pixel is generated on the basis of position information of the pixel and position information of a viewpoint corresponding to the pixel.

### FIELD OF THE INVENTION

The present invention relates to a multi-viewpoint 3D image display apparatus and, more particularly, to a multi-viewpoint composite image apparatus using computer graphics (CG).

### BACKGROUND OF THE INVENTION

Conventionally, various methods have been proposed as methods of displaying a 3D image. Of these methods, 3D image display methods using binocular parallax, in which images with parallax for left and right eyes are displayed to produce stereopsis for an observer, are widely used. Especially, many 2-viewpoint 3D display methods, in which images acquired/generated at two different view positions are displayed, have been proposed and put into practical use.

Multi-viewpoint 3D image display methods with a wider visual field and smooth motion parallax have also been recently proposed.

For example, in an image processing apparatus described in Japanese Patent Application Laid-Open No. 2001-346226, a 3D photo system, in which a parallax map representing the depth distribution of a stereoscopic image taken by using a camera with a 3D photo adapter is extracted is proposed. Multi-viewpoint image sequences of the object, from a plurality of viewpoints, are created on the basis of the parallax map and the stereoscopic image without actual photographing. The multi-viewpoint image sequences compose a pixel arrangement corresponding to a predetermined optical member to create a multi-viewpoint composite image. The created multi-viewpoint composite image is printed by a printing device and observed through an optical member such as a renticular lens so that smooth motion parallax can be observed.

On the other hand, in the field of 3D display, a number of 2-viewpoint 3D image display methods are put into practice. In recent years, multi-viewpoint 3D displays capable of expressing smooth motion parallax have been proposed. There are also proposed super-multi-viewpoint 3D displays which can reduce the observer's sense of fatigue or discomfort by implementing a super-multi-viewpoint state wherein two or more parallax images enter the pupils of the observer (Yoshihiro Kajiki, et al., “Super-multi-view Stereoscopic Display with Focused Light-beam Array (FLA)”, 3D Image Conference 1996, pp. 108-113, 1996).

All the above-described 3D image display methods create a multi-viewpoint composite image by rearranging 2D images acquired/generated at a number of view positions into a pixel arrangement corresponding to a specific optical system. When a person observes the multi-viewpoint composite image through the specific optical system, he/she can perceive it as a 3D image. Rearrangement into a pixel arrangement using a renticular lens as an optical system will be described here with reference to FIGS. 12 and 13.

FIG. 12 schematically illustrates a state wherein 2D images are acquired by using four cameras in the multi-viewpoint 3D display method. The optical centers of four cameras 1201 to 1204 with parallel lines of sight are arrayed on a base line 1205 at a predetermined interval. The pixels of 2D images acquired at the respective camera positions are rearranged into a pixel arrangement to generate a multi-viewpoint composite image such that stereopsis can be obtained upon observing the multi-viewpoint composite image by using a renticular lens shown in FIG. 13.

For example, let Pⱼₘₙ (m and n are indices of the pixel arrangement in the horizontal and vertical directions) be the pixel value of the jth viewpoint. In this case, the jth image data is expressed as a 2D arrangement given by

Pⱼ₁₁Pⱼ₂₁Pⱼ₃₁ . . .

Pⱼ₁₂Pⱼ₂₂Pⱼ₃₂ . . .

Pⱼ₁₃Pⱼ₂₃Pⱼ₃₃ . . .

Since a renticular lens is used as the optical system to observe, in the pixel arrangement for composition, the image of each viewpoint is decomposed into stripes every line in the vertical direction, and the decomposed images equal in number to the viewpoints are rearranged in a reverse order of view positions. Hence, the multi-viewpoint composite image is a stripe-shaped image given by

P₄₁₁P₃₁₁P₂₁₁P₁₁₁P₄₂₁P₃₂₁P₂₂₁P₁₂₁P₄₃₁P₃₃₁P₂₃₁P₁₃₁ . . .

P₄₁₂P₃₁₂P₂₁₂P₁₁₂P₄₂₂P₃₂₂P₂₂₂P₁₂₂P₄₃₂P₃₃₂P₂₃₂P₁₃₂ . . .

P₄₁₃P₃₁₃P₂₁₃P₁₁₃P₄₂₃P₃₂₃P₂₂₃P₁₂₃P₄₃₃P₃₃₃P₂₃₃P₁₃₃ . . .

A viewpoint I represents the image at the left end (I in FIG. 13), and a viewpoint IV represents the image at the right end (IV in FIG. 13). The order of view positions is reversed to the camera arrangement order because an image in one pitch of the renticular lens is observed in an inverted state in the horizontal direction.

When the 2D image at each original view position is an N-viewpoint image with a size of H×v, the multi-viewpoint composite image has a size of X (=N×H)×v. Next, the pitch of the multi-viewpoint composite image is adjusted to that of the renticular lens. Since N pixels are present in one pitch at a resolution of RP dpi, 1 pitch=N/RP inch. Since the pitch of the renticular lens is RL inch, the image is enlarged by RL×RP/N times in the horizontal direction to adjust the pitch. At this time, the number of pixels in the vertical direction must be (RL×RP/N)×Y. Hence, the magnification is adjusted by multiplying the size by (RL×RP×Y)/(N×v) times in the vertical direction.

An image is generated by scaling the multi-viewpoint composite image in the horizontal and vertical directions and printed. When a print result 1301 shown in FIG. 13 is observed through a renticular lens 1302, the image can be observed as a 3D image.

In FIG. 12, four cameras are used for photographing. A multi-viewpoint composite image can be generated in the same way even when photographing is done by using more cameras or by moving a single camera, or by using the method described in Japanese Patent Application Laid-Open No. 2001-346226 described above in which a stereoscopic image is input by attaching a stereoscopic adapter to a camera, corresponding points are extracted from the stereoscopic image, a parallax map representing the depth is created from the corresponding point extraction result, and the created parallax map is forward-mapped to create a 2D image of a new viewpoint without photographing.

In a 3D space solely within created in a computer by 3D computer graphics, a multi-viewpoint composite image can be created by laying out virtual cameras like 1201 to 1204 in FIG. 12, generating 2D images at the respective positions, and compositing them in the above-described manner.

In the prior arts, a multi-viewpoint composite image of a multi-viewpoint 3D display method is generated by generating 2D images at predetermined view positions and rearranging them into a pixel arrangement corresponding to a display method for a specific optical system.

That is, a temporary storage area to hold the temporarily created 2D images is necessary. When the number of viewpoints increases, the storage capacity to store the 2D images also increases.

In addition, since a 3D image is generated after temporarily generating 2D images at the respective view positions. If a 3D moving image is to be displayed, the frame interval depends on the 2D image generation time.

Furthermore, to shorten the 2D image generation time, the 2D images of the respective viewpoints must be generated by parallelly combining a plurality of 2D image generation apparatuses. This increases the scale and cost of the apparatus.

### SUMMARY OF THE INVENTION

The present invention has been proposed to solve the conventional problems, and has as its object to provide a 3D image generation program for generating a 3D image capable of producing stereopsis from a plurality of observation positions, comprising: a first step of inputting a 3D scene; and a second step of generating information of a pixel of the 3D image on the basis of the 3D scene, wherein in the second step, the information of the pixel is generated on the basis of position information of the pixel and position information of a viewpoint corresponding to the pixel.

Another aspect of the present invention is to provide a 3D image generation system for generating a 3D image capable of producing stereopsis from a plurality of observation positions, comprising: input unit which inputs a 3D scene; and pixel generation unit arranged to generate information of a pixel of the 3D image on the basis of the 3D scene, the pixel generation unit arranged to generate the information of the pixel on the basis of position information of the pixel and position information of a viewpoint corresponding to the pixel.

Furthermore, another aspect of the present invention is to provide a 3D image generation apparatus for generating a 3D image capable of producing stereopsis from a plurality of observation positions, comprising: an input unit which inputs a 3D scene; and a pixel generation unit which generates information of a pixel of the 3D image on the basis of the 3D scene, the pixel generation unit generating the information of the pixel on the basis of position information of the pixel and position information of a viewpoint corresponding to the pixel.

Other features and advantages of the present invention will be apparent from the following descriptions taken in conjunction with the accompanying drawings, in which like reference characters designate the same or similar parts throughout the figures thereof.

### BRIEF DESCRIPTION OF THE DRAWINGS

FIG. 1 is a block diagram showing the arrangement of a multi-viewpoint composite image generation apparatus according to the first embodiment of the present invention;

FIG. 2 is a block diagram showing the arrangement of the multi-viewpoint composite image generation apparatus according to the first embodiment of the present invention;

FIG. 3 is a flowchart showing the operation of the multi-viewpoint composite image generation apparatus according to the first embodiment of the present invention;

FIG. 4 is a view showing the layout of models and cameras in a 3D space according to the first embodiment of the present invention;

FIG. 5 is an explanatory view of the pixel arrangement of a multi-viewpoint composite image according to the first embodiment of the present invention;

FIG. 6 is a view showing the principle of a ray tracing according to the present invention;

FIG. 7 is a flowchart showing pixel value calculation processing by the ray tracing according to the present invention;

FIG. 8 is a block diagram showing the arrangement of a multi-viewpoint composite image generation apparatus according to the second embodiment of the present invention;

FIG. 9 is a view showing an example of a method using a renticular lens in a conventional 3D display;

FIG. 10 is a flowchart showing the operation of the multi-viewpoint composite image generation apparatus according to the second embodiment of the present invention;

FIGS. 11A to 11C are views for explaining a scanning method in multi-viewpoint composite image generation according to the second embodiment of the present invention;

FIG. 12 is a schematic view for explaining conventional multi-viewpoint 3D image photographing; and

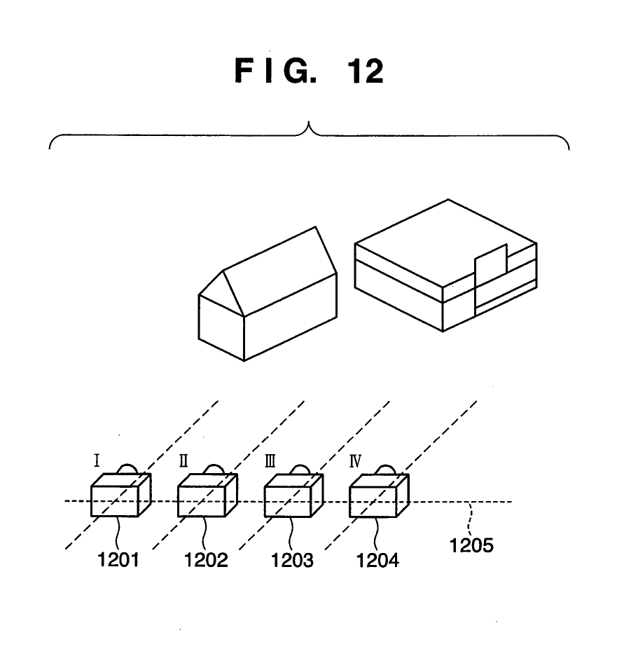

FIG. 13 is a schematic view showing a conventional multi-viewpoint 3D image display method using a renticular lens.

### DETAILED DESCRIPTION OF THE PREFERRED EMBODIMENTS

An object exemplified by the embodiments is to implement a 3D image generation program and 3D image generation system which can efficiently generate a 3D image capable of producing stereopsis for a plurality of observation positions.

The embodiments of the present invention will be described below.

### First Embodiment

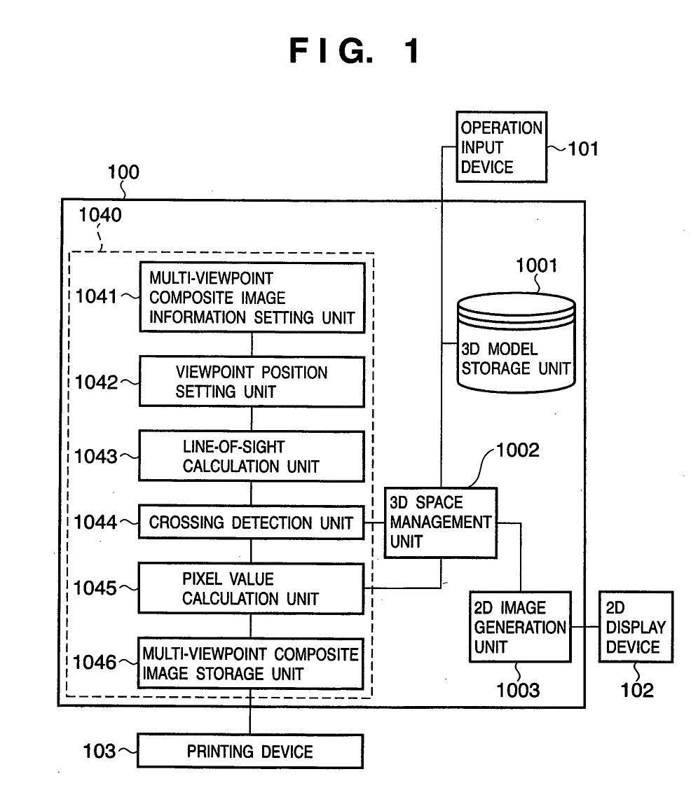

FIG. 1 is a block diagram showing the functional arrangement of a 3D photo print system using a multi-viewpoint composite image generation apparatus (3D image generation apparatus) according to the first embodiment of the present invention.

A multi-viewpoint composite image generation apparatus 100 includes, e.g., a general-purpose personal computer and generates a multi-viewpoint composite image (3D image) by using information of a 3D space where 3D models are laid out and a specific optical system to reproduce a 3D image.

An operation input device 101 serving as a pointing device includes, e.g., a mouse or joystick with which the operator inputs an operation command to the multi-viewpoint composite image generation apparatus 100 or moves a 3D model in the 3D space.

A 2D display device 102 includes a CRT or liquid crystal display to display a 2D image by projecting the 3D space two-dimensionally. The operator lays out the 3D models in the 3D space while observing the display result on the 2D display device 102.

A printing device 103 prints the multi-viewpoint composite image generated by the multi-viewpoint composite image generation apparatus 100. The multi-viewpoint composite image generation apparatus 100, operation input device 101, and printing device 103 are connected by using an interface such as USB (Universal Serial Bus).

The internal block arrangement of the multi-viewpoint composite image generation apparatus 100 will be described next. A 3D model storage unit 1001 stores 3D models created by general 3D model creation software. Each 3D model includes apexes, reflection characteristic, and texture.

A 3D space management unit 1002 executes management in the 3D space so that what kind of 3D model is laid out by the operator in what kind of 3D space, and where the light source and camera are laid out can be managed.

A 2D image generation unit 1003 generates a 2D image at a specific camera position in the current 3D space and displays the 2D image on the 2D display device 102.

A multi-viewpoint composite image generation unit 1040 generates a multi-viewpoint composite image in accordance with an optical system to finally observe the 3D image. The generated multi-viewpoint composite image is output to the printing device 103. When a predetermined optical system (stereoscopic display device such as a renticular lens) is used for the print result, a 3D image can be observed.

The internal arrangement of the multi-viewpoint composite image generation unit 1040 will be described below in detail. A multi-viewpoint composite image information setting unit 1041 sets viewpoint information or pixel arrangement determined from the optical system to observe the generated multi-viewpoint composite image. That is, the multi-viewpoint composite image information setting unit 1041 sets the viewpoint information and pixel arrangement of the multi-viewpoint composite image on the basis of the optical characteristic of the stereoscopic display device such as a renticular lens.

A view position setting unit 1042 sets a view position corresponding to the multi-viewpoint composite image to be created currently on the basis of the viewpoint information set by the multi-viewpoint composite image information setting unit 1041.

A line-of-sight calculation unit 1043 calculates a ray to connect the current view position and a pixel to be generated, on the basis of the view position and pixel arrangement of the multi-viewpoint composite image to be generated, which are set by the multi-viewpoint composite image information setting unit 1041 and view position setting unit 1042.

A crossing detection unit 1044 determines whether the ray calculated by the line-of-sight calculation unit 1043 crosses a 3D model (3D scene) stored in the 3D space management unit 1002.

A pixel value calculation unit (pixel generation unit) 1045 sets the pixel value of a specific pixel (information of a pixel included in the multi-viewpoint composite image) to a predetermined pixel position of a multi-viewpoint composite image storage unit 1046 on the basis of information obtained by causing the crossing detection unit 1044 to determine whether the ray crosses the 3D model.

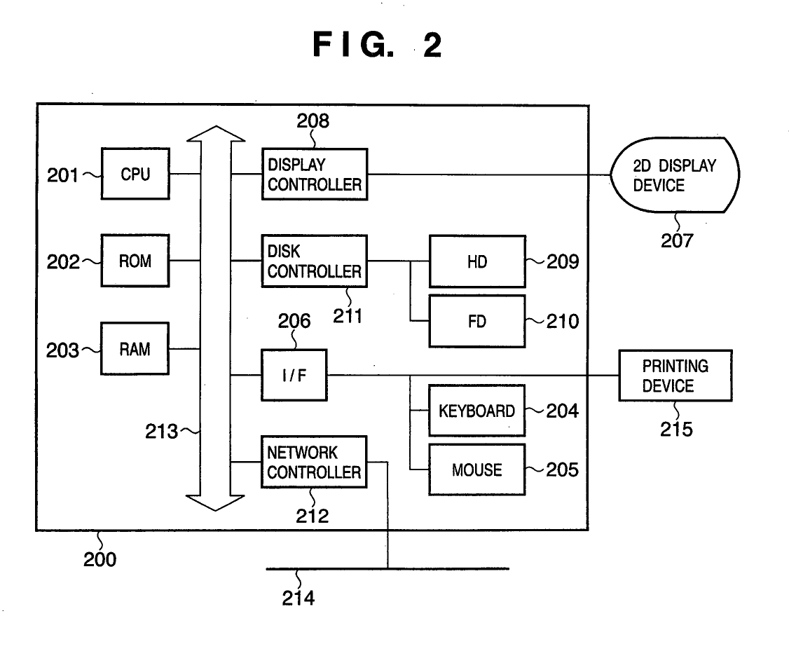

As shown in FIG. 2, the multi-viewpoint composition apparatus 100 of this embodiment includes a general-purpose personal computer 200. A CPU 201, ROM 202, RAM 203, keyboard 204, mouse 205, interface (I/F) 206, 2D display device 207 serving as a display unit, display controller 208, hard disk (HD) 209, floppy® disk (FD) 210, disk controller 211, and network controller 212 are connected through a system bus 213.

The system bus 213 is connected to a network 214 through the network controller 212. The CPU 201 systematically controls the components connected to the system bus 213 by executing software stored in the ROM 202 or HD 209 or software supplied by the FD 210.

That is, the CPU 201 executes control to implement each function of this embodiment by reading out a predetermined processing program from the ROM 202, HD 209, or FD 210 and executing the program.

The RAM 203 functions as the main storage unit or work area of the CPU 201. The I/F 206 controls an instruction input from the pointing device such as the keyboard 204 or mouse 205. The display controller 208 controls display, e.g., GUI display on the 2D display device 207. The disk controller 211 controls access to the HD 209 and FD 210 which store a boot program, various applications, variant files, user files, a network management program, and the processing program of this embodiment. The network controller 212 executes two-way data communication with a device on the network 214.

A multi-viewpoint composite image can be generated by the operations of the above-described units. In this embodiment, the multi-viewpoint composite image generation apparatus 100 is formed from a computer having the above-described configuration. However, the present invention is not limited to this, and the multi-viewpoint composite image generation apparatus 100 may include a dedicated processing board or chip specialized to the processing.

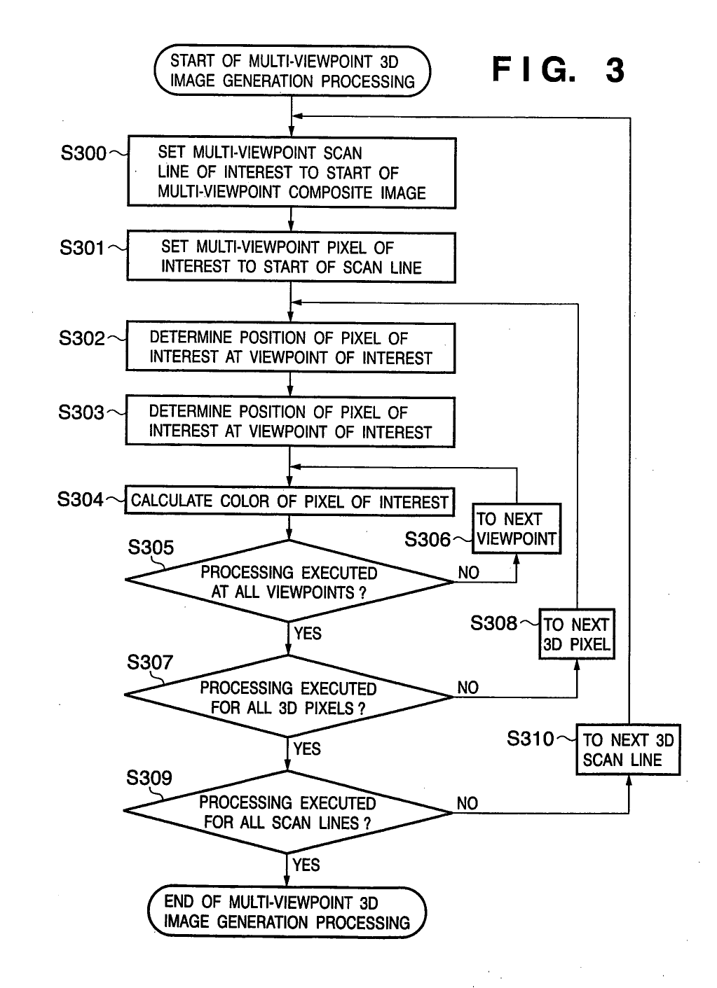

Processing of the multi-viewpoint composite image generation apparatus 100 according to this embodiment will be described next in detail with reference to FIGS. 3 to 5. A multi-viewpoint composite image is generated by composing image information acquired at four view positions.

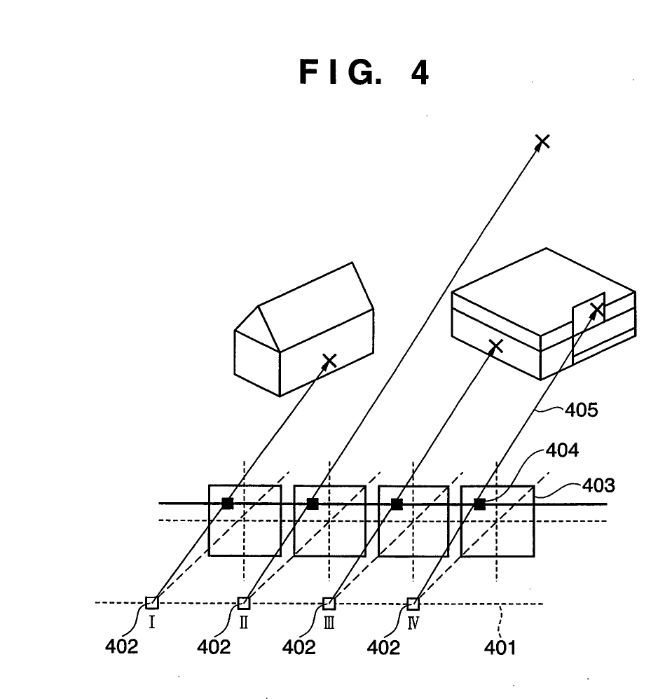

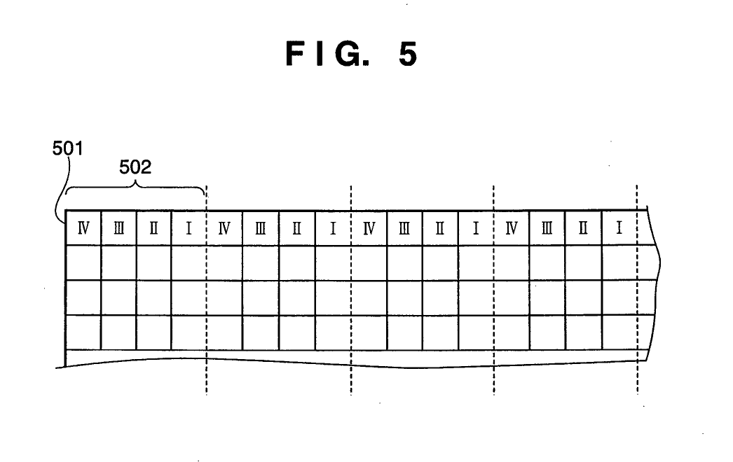

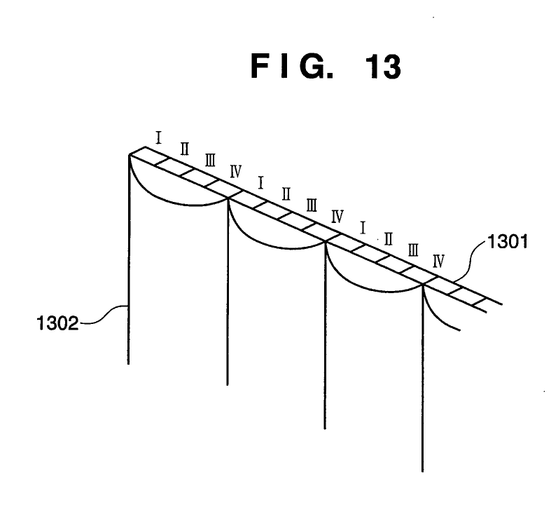

FIG. 4 shows a state wherein viewpoints (optical centers) 402 are arranged on a base line 401. FIG. 5 shows the pixel arrangement of a multi-viewpoint composite image obtained by compositing image information acquired at four viewpoints I to IV in FIG. 4. Referring to FIG. 4, an image plane to take an image is expressed on the full plane of the viewpoint (optical center) (403). A case wherein the multi-viewpoint composite image shown in FIG. 4 is to be observed through a renticular lens, as shown in FIG. 13, will be described.

First, the scan line of the multi-viewpoint composite image to be generated is set at the start of the pixel arrangement. That is, the scan line of interest of the multi-viewpoint composite image is set to a scan line 501 in FIG. 5 (S300).

A composite pixel of interest is set to the start of the scan line set in step S300. That is, a composite pixel of interest is set to a first pixel 502 of the multi-viewpoint composite image in FIG. 5 (S301).

A view position necessary for the set composite pixel of interest is set. For example, when the multi-viewpoint composite image should be observed through a renticular lens, as shown in FIG. 13, the sequent of view positions in the pixels of the multi-viewpoint composite image to be generated on the basis of the optical characteristic of the renticular lens starts from a view position IV. Hence, the view position is set to IV (S302).

A pixel position to be calculated in the set view position is determined, and the pixel value of the pixel is calculated. More specifically, the pixel value of the pixel is calculated from light source information and 3D model information nearest to the viewpoint, which crosses the ray from the viewpoint (optical center) IV in FIG. 4 (S303).

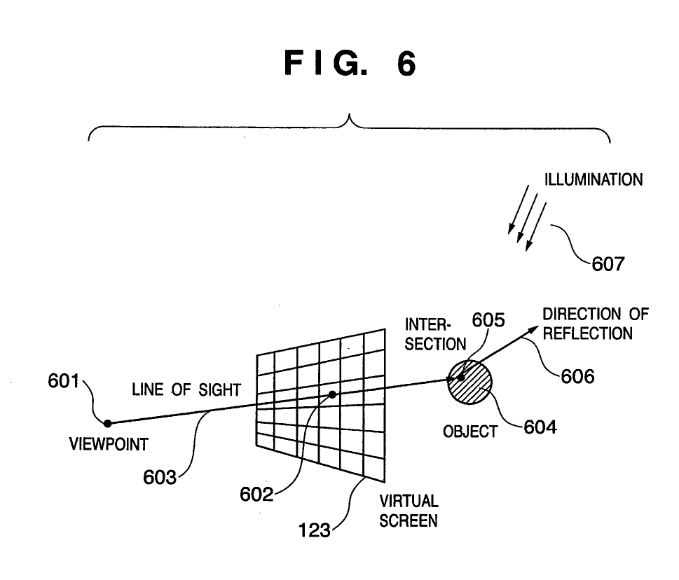

As a method of calculating the pixel value of a specific pixel of a multi-viewpoint composite image, for example, a ray tracing described in Foley, van Dam, Feiner, Hughes, “Computer Graphics: principles and practice 2nd ed.” Addison-Wesley, 1996 can be used. The pixel value calculation method will be described below with reference to FIG. 6.

In rendering by the ray tracing, an intersection 605 between a line 603 of sight obtained from a viewpoint 601 and pixel 602 of interest and a graphic pattern 604 located nearest to the viewpoint is obtained. The luminance value at the intersection 605 is obtained. In addition, a straight line 606 corresponding to reflected light/refracted light of the ray from the intersection 605 is extended in accordance with the characteristic of the graphic pattern which the line 603 of sight crosses. An intersection between a graphic pattern and each straight line corresponding to reflected light/refracted light from an intersection is newly obtained. A new ray corresponding to reflected light/refracted light is extended from the intersection. This binary tree processing is repeated. The luminance values at the intersections of the rays which form the binary tree are added at a predetermined ratio, thereby obtaining the luminance value of each pixel on the screen.

In obtaining the luminance value at each intersection, it may be determined whether a graphic pattern to block a ray vector from a given light source 607 is present. With this processing, more real rendering can be executed by shadowing the displayed graphic pattern.

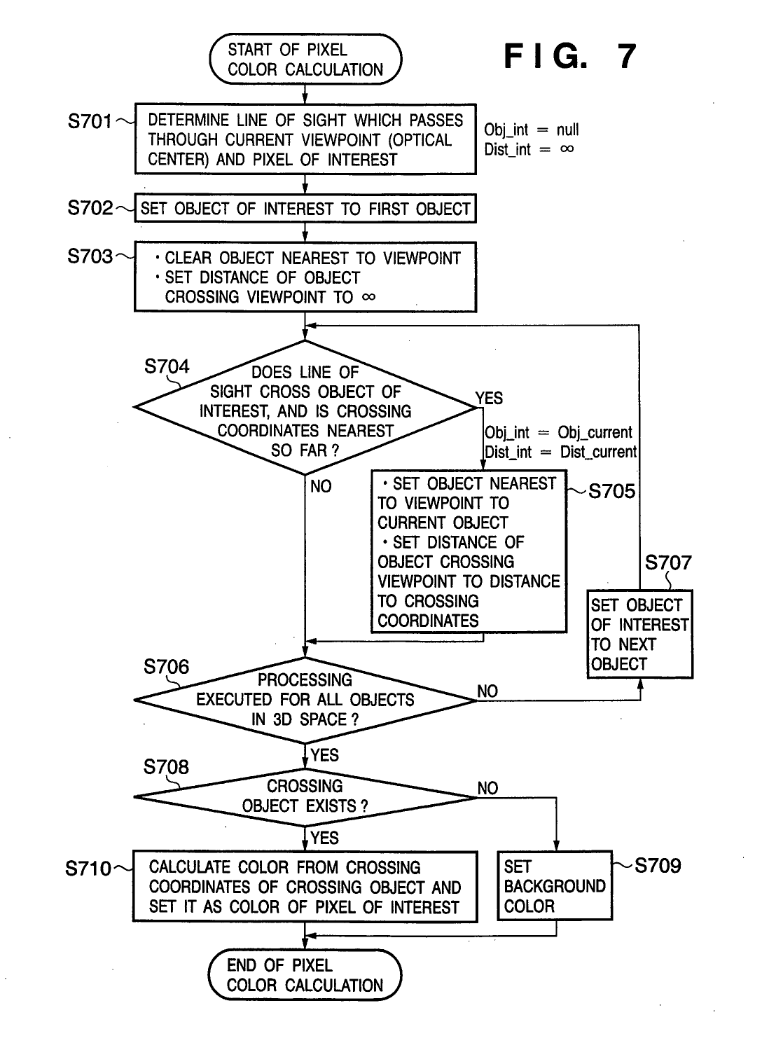

The flow of the ray tracing processing method will be described with reference to the flowchart shown in FIG. 7.

First, a ray passing through the current viewpoint (optical center) and the pixel of interest is calculated (S701) and set to the first one of the 3D models present in the current 3D space (S702). This 3D model is defined as, e.g., a set of a plurality of triangular patches.

A variable representing whether an object (triangular patch) crossing the ray calculated in step S701 is present is cleared. In addition, a variable representing the distance to the crossing object (triangular patch) is set to infinite (S703).

It is determined whether the ray calculated in step S701 crosses any one of the triangular patches of the 3D model of interest, and if YES, it is determined whether the distance to the ray is shortest (S704). If both conditions are satisfied, the crossing triangular patch of the 3D model of interest and the distance are stored in the variables (S705).

It is determined for all 3D models laid out in the target 3D space whether crossing to the ray is done (S706). If NO in step S706, the flow advances to step S707 to set the 3D model of interest to the next 3D model (second 3D model) (S707), and the flow returns to step S704.

If crossing to all the target 3D models is done, it is determined by referring to a predetermined variable Obj_int whether an object crossing the currently set ray is present (S708).

If no crossing object is present (Obj_int=null), a predetermined pixel of the multi-viewpoint composite image is set to the background color (S709). If a crossing object is present, a pixel value is calculated from the reflection/refraction characteristic set for each apex of the triangular patch belonging to the crossing 3D model. The calculated pixel value is set as the pixel value of the pixel (color information of the pixel) of the multi-viewpoint composite image (S710). Then, the processing is ended, and the flow returns to FIG. 3.

In step S304 in FIG. 3, the flow is branched to loop the processing at all view positions necessary for the composite pixel. If a view position to be calculated remains, the processing moves to the next view position in step S305. A necessary pixel at the new view position is calculated again in step S303.

In step S306, the flow is branched to calculate all composite pixels in the multi-viewpoint scan line. If a composite pixel to be calculated remains, the processing moves to the next 3D pixel in step S307. Calculation of the new composite pixel is executed again in step S302.

In step S308, the flow is branched to calculate all scan lines in the multi-viewpoint scan line. If a scan line to be calculated remains, the processing moves to the next scan line in step S309. Calculation of the new scan line is executed again in step S300.

The multi-viewpoint composite image created in accordance with the above-described processing flow is printed by the printing device 103 in FIG. 1. When the print result is observed through a predetermined optical system, a 3D image with smooth motion parallax reproduced can be observed.

As described above, in this embodiment, in generating a multi-viewpoint composite image containing a pixel arrangement corresponding to various multi-viewpoint 3D display methods, the pixel value of only a predetermined one of the multi-viewpoint composite image pixels at a corresponding view position is calculated. The pixel values are sequentially calculated for each view position to calculate the pixels of the multi-viewpoint composite image. These processing operations are repeated for all pixels of the multi-viewpoint composite image, thereby generating the multi-viewpoint composite image.

In the conventional 3D image generation method, 2D images are taken at a plurality of view positions and composited into a multi-viewpoint composite image. In this embodiment, the pixel value (pixel information) is generated directly from a 3D scene on the basis of the position information of a pixel contained in the multi-viewpoint composite image on the basis of the input 3D scene and the position information of each viewpoint corresponding to the pixel. For this reason, it is unnecessary to temporarily create and store a 2D image at each view position.

Hence, the temporary storage capacity to temporarily store the 2D image at each view position can be reduced. In addition, the processing and apparatus (system) configuration to generate the multi-viewpoint composite image can be simplified.

Additionally, in printing the multi-viewpoint composite image by the printing device 103, the multi-viewpoint composite image can be generated directly from the 3D scene for each scan line or several scan lines and output to the printing device 103. For this reason, print processing can be performed smoothly and quickly. Hence, the 3D image can be observed from a plurality of observation positions easily and quickly.

### Second Embodiment

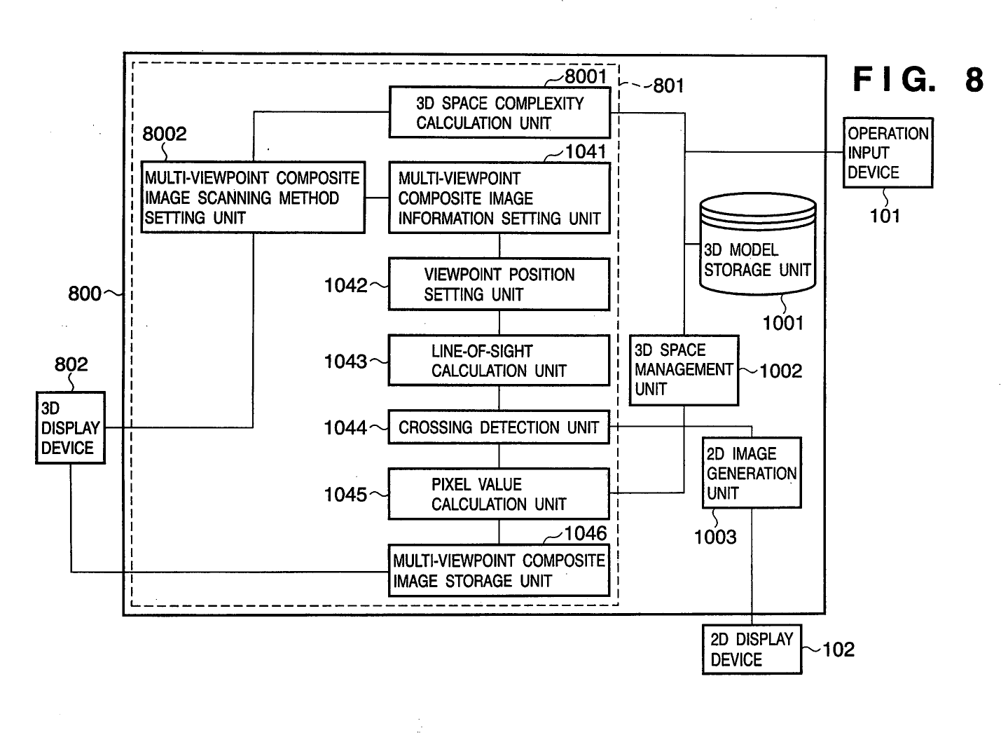

FIG. 8 is a block diagram showing the functional arrangement of 3D display system using a multi-viewpoint composite image generation apparatus (3D image generation apparatus) according to the second embodiment of the present invention. In the first embodiment, the multi-viewpoint composite image generation apparatus is applied to a 3D photo print system. In the second embodiment, the multi-viewpoint composite image generation apparatus is applied to a 3D display system.

The same reference numerals as in FIG. 1 denote parts to execute the same operations in FIG. 8, and a description thereof will be omitted. The physical configuration can also be the same as in the first embodiment (FIG. 2), and a description thereof will be omitted.

In this embodiment, the 3D display system includes an operation input device 101, 2D display device 102, multi-viewpoint composite image generation apparatus 800, and a stereoscopic display device 802. The multi-viewpoint composite image generation apparatus 800 includes a 3D model storage unit 1001, 3D space management unit 1002, 2D image generation unit 1003, and multi-viewpoint composite image generation unit 801. A multi-viewpoint composite image generated by the multi-viewpoint composite image generation unit 801 is output to the stereoscopic display device 802 so that a 3D image is presented.

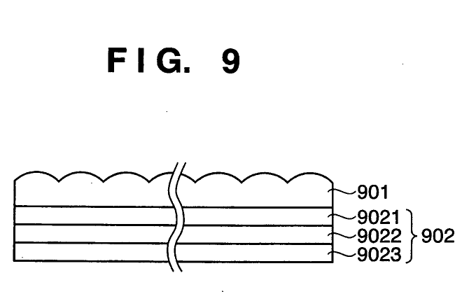

In the stereoscopic display device 802, for example, a liquid crystal display unit 902 is located under a renticular lens 901, as shown in FIG. 9. The liquid crystal display unit 902 includes glass substrates 9021 and 9023 and a display pixel unit 9022 arranged between the glass substrates 9021 and 9023. The liquid crystal display pixel unit 9022 is arranged on the focal plane of the renticular lens 901.

When a stripe image of a 2D image acquired/generated at a predetermined photographing position (view position) is rendered on the display pixel unit, stereopsis can be obtained by presenting images with parallax to the left and right eyes of the observer.

Except the 3D display method using the renticular lens, for example, a method using the principle of a parallax barrier method (H. Kaplan, “Theory of Parallax Barriers”, J.SMPTE, Vol. 50, No. 7, pp. 11-21, 1952) can be used. In this case, a composite image is displayed, and images with parallax are presented to the observer through a slit (parallax barrier) having a predetermined opening and provided at a position spaced apart from the stripe image by a predetermined distance, thereby obtaining stereopsis.

In a 3D display apparatus described in Japanese Patent Application Laid-Open No. 3-119889, the parallax barrier is electronically formed by, e.g., a transmission liquid crystal element. The shape or position of the parallax barrier is electronically controlled and changed.

In a 3D image display apparatus described in Japanese Patent Application Laid-Open No. 2004-007566, a multi-viewpoint composite image having a matrix shape is formed. An aperture mask corresponding to the matrix array is placed on the entire surface, and each horizontal pixel array is made incident on only the corresponding horizontal array of the mask by using, e.g., a horizontal renticular lens, thereby making the degradation in resolution of the multi-viewpoint composite image unnoticeable.

The pixel arrangement of the multi-viewpoint composite image is determined by the characteristic of the display optical system (stereoscopic display device) of the multi-viewpoint composite image. Hence, any method capable of definitely determining the pixel arrangement of the multi-viewpoint composite image in accordance with the display optical system can be applied.

The functional blocks in the multi-viewpoint composite image generation apparatus 800 according to this embodiment will be described next. The same reference numerals as in FIG. 1 of the first embodiment denote components having the same functional contents, and a description thereof will be omitted.

A 3D space complexity calculation unit 8001 calculates the complexity of the current 3D space to approximately estimate the rendering time per viewpoint. A multi-viewpoint composite image scanning method setting unit 8002 controls, on the basis of the complexity of the current 3D space determined by the 3D space complexity calculation unit 8001, the scanning method of the scan line of the multi-viewpoint composite image to be output to the 3D display.

A multi-viewpoint composite image information setting unit 1041 sets the view position or composite pixel (pixel position information) to be created on the basis of the scanning method set by the multi-viewpoint composite image scanning method setting unit 8002 and the pixel arrangement corresponding to the 3D display method of the stereoscopic display device 802. Processing operations in the remaining functional blocks are the same as in FIG. 1.

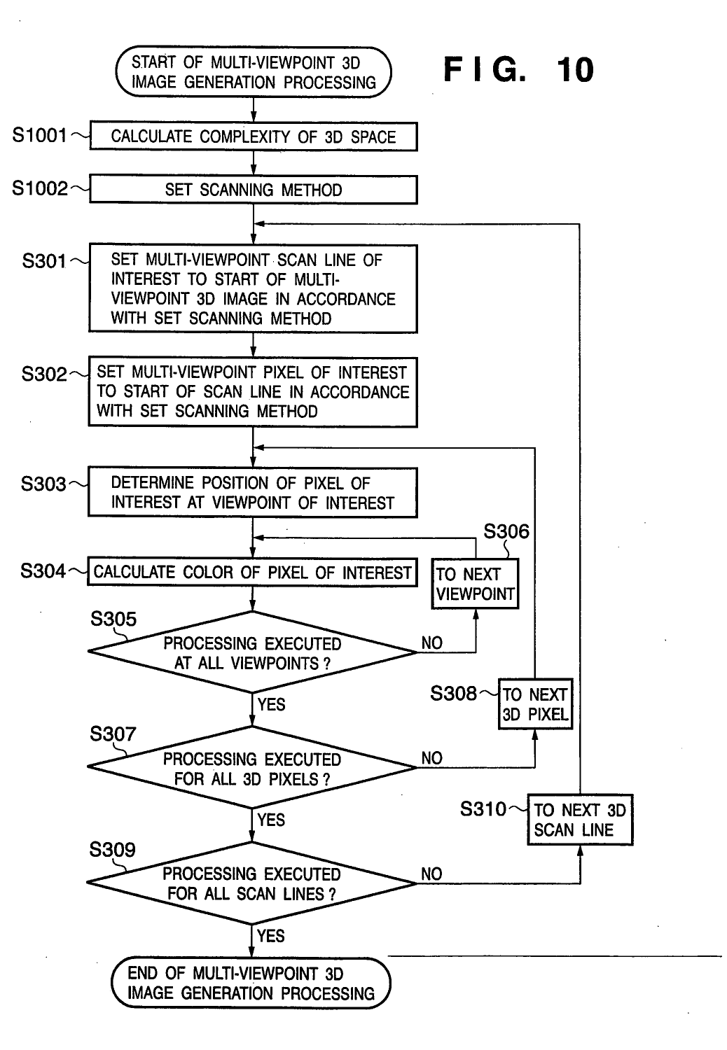

The flow of the above-described processing will be described with reference to the flowchart shown in FIG. 10. The same step numbers as in FIG. 3 denote the same processing in FIG. 10. Hence, only processing in steps S1001 and S1002 different from the processing shown in FIG. 3 will be described.

First, the complexity of the current 3D space is calculated (S1001). In this embodiment, for example, the number of 3D models present in the 3D space and the shapes and number of polygons such as triangular patches of each 3D model are calculated. The complexity of the 3D space is determined on the basis of whether the number or the like is larger than a predetermined value. Then, a scan line to update the multi-viewpoint composite image to be output to the stereoscopic display device 802 is set (S1002).

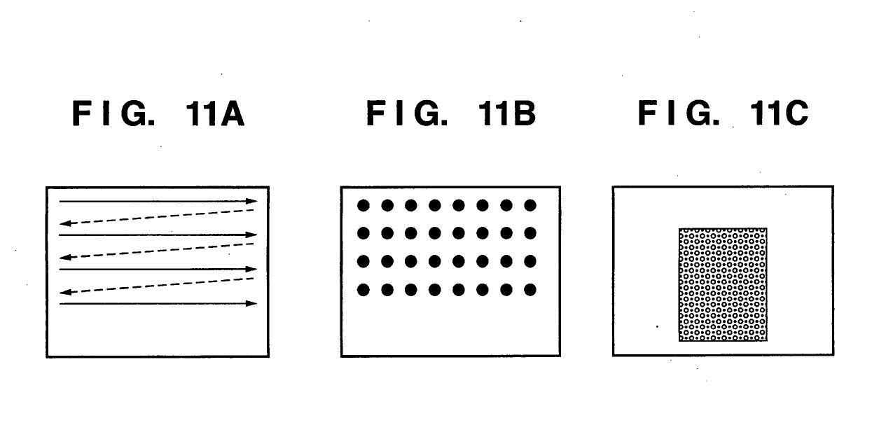

If it is determined that the current 3D space is complex, an interlaced scanning method is selected/set to render the multi-viewpoint composite image every other scan line, as shown in FIG. 11A. When the interlaced scanning method is used, the generation time of one multi-viewpoint composite image can be shortened.

The scanning method can also be selected/set by determining the complexity of the 3D space depending on the presence/absence of a motion of 3D models in the 3D space. For example, when 3D models in the 3D space do not have so large motion, and the number of 3D models in the 3D space is small (or the number of polygons such as triangular patches of each 3D model is small), scanning is executed for each block containing a specific number of pixels, as shown in FIG. 11B.

Alternatively, as shown in FIG. 11C, scanning may be executed by setting only a specific region of the multi-viewpoint composite image to a rendering region. In this case, a neighboring region of a 3D model manipulated through the operation input device 101 can be set as the change region.

As described above, in this embodiment, the multi-viewpoint composite image is generated directly from a 3D scene even in the 3D display system, and it is unnecessary to temporarily generate and store a 2D image at each view position, as in the first embodiment.

In this embodiment, since various scanning methods can be applied even when not a still image but a moving image is displayed on the stereoscopic display device 802, the frame rate of 3D video display can be increased.

As described above, a multi-viewpoint composite image having various pixel arrangements corresponding to diverse 3D display methods such as the 3D photo print system of the first embodiment or the 3D display system of the second embodiment can easily be generated only by changing the definition of the pixel arrangement or view position.

As rendering by the ray tracing of the first and second embodiments, the most simple method has been described. However, various fast methods to detect the presence/absence of crossing between a ray and an object in a 3D space can also be used. For example, a method of executing crossing calculation by using the approximate shape of a complex 3D model, a method of generating the hierarchical structure of a 3D space and using its information, or a method of segmenting a 3D space in accordance with models (objects) in it to improve the calculation efficiency can be applied.

The present invention can be applied to a system including a plurality of devices or an apparatus including a single device. The present invention can also be implemented by supplying a storage medium which stores software program codes to implement the functions of the above-described embodiments to the system or apparatus and causing the computer (or CPU or MPU) of the system or apparatus to read out and execute the program codes stored in the storage medium.

The functions of the above-described embodiments are implemented not only when the readout program codes are executed by the computer but also when the OS running on the computer performs part or all of actual processing on the basis of the instructions of the program codes.

The functions of the above-described embodiments can also be implemented when the program codes read out from the storage medium are written in the memory of a function expansion board inserted into the computer or a function expansion unit connected to the computer, and the CPU of the expansion board or expansion unit performs part or all of actual processing on the basis of the instructions of the program codes.

According to the embodiments, information of each pixel of a 3D image capable of producing stereopsis is generated on the basis of a 3D scene without generating and holding a plurality of 2D images at a plurality of viewpoints, unlike the prior arts.

For this reason, the image information storage area can be reduced, and processing and the apparatus can be simplified so that a 3D image can be generated efficiently.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2004-350577 filed on Dec. 3, 2004, which is hereby incorporated by reference herein.

What is claimed is:

1. A 3D image generation program for generating a 3D image capable of producing stereopsis from a plurality of observation positions, comprising:
a first step of inputting a 3D scene; and
a second step of generating information of a pixel of the 3D image on the basis of the 3D scene,
wherein in the second step, the information of the pixel is generated on the basis of position information of the pixel and position information of a viewpoint corresponding to the pixel.

2. The program according to claim 1, wherein the information of the pixel is generated by a ray tracing.

3. The program according to claim 1, wherein the position information of each viewpoint is information corresponding to a characteristic of a stereoscopic display device.

4. The program according to claim 1, further comprising a step of setting a pixel arrangement of the 3D image in accordance with a characteristic of a stereoscopic display device.

5. The program according to claim 1, further comprising a step of determining, on the basis of complexity of the 3D scene, the information of the pixel to be generated.

6. A 3D image generation system for generating a 3D image capable of producing stereopsis from a plurality of observation positions, comprising:
input unit which inputs a 3D scene; and
pixel generation unit arranged to generate information of a pixel of the 3D image on the basis of the 3D scene,
said pixel generation unit arranged to generate the information of the pixel on the basis of position information of the pixel and position information of a viewpoint corresponding to the pixel.

7. A 3D image generation apparatus for generating a 3D image capable of producing stereopsis from a plurality of observation positions, comprising:
an input unit which inputs a 3D scene; and
a pixel generation unit which generates information of a pixel of the 3D image on the basis of the 3D scene,
said pixel generation unit generating the information of the pixel on the basis of position information of the pixel and position information of a viewpoint corresponding to the pixel.
